(19) United States
(12) Patent Application Publication
(10) Pub. No.: US 2025/0153524 A1
(43) Pub. Date: May 15, 2025

(54) FILTER SUB-ASSEMBLY FOR AN UPPER-STOP ASSEMBLY OF A SUSPENSION STRUT OF A MOTOR VEHICLE, AND ASSOCIATED ASSEMBLY, SUSPENSION STRUT AND ASSEMBLY METHOD

(71) Applicant: NTN EUROPE, Annecy (FR)

(72) Inventors: Alexandre BAUDU, Annecy (FR); Vincent POURROY-SOLARI, Thônes (FR)

(73) Assignee: NTN EUROPE, Annecy (FR)

(21) Appl. No.: 18/880,315

(22) PCT Filed: Jul. 3, 2023
(86) PCT No.: PCT/EP2023/068276

§ 371 Date: Dec. 31, 2024

(30) Foreign Application Priority Data
Jul. 7, 2022 (FR) FR2206993

(51) Int. Cl. B60G 15/06

(52) U.S. Cl. CPC B60G 15/067; B60G 2202/30; B60G 2204/128

(57) ABSTRACT

The invention relates to a filter sub-assembly (10) comprising: a filter block (20); a lower support (30) having a central portion (31) and a peripheral portion (32) surrounding the central portion (31); and a cover (40) comprising a central portion (41) bearing against an upper face (23) of the filter block (20), and a peripheral portion (42) surrounding the central portion (41) and bearing against the peripheral portion (32) of the lower support (30), the filter sub-assembly (10) comprising a locking washer (90), a first element from among the lower support (30) and the cover (40) being located between the locking washer (90) and a second element from among the lower support (30) and the cover (40), flaps (50) and associated notches (96) being formed on the locking washer (90) and the second element to allow them to be fixed together in the manner of a bayonet fixing.

### TECHNICAL FIELD OF THE INVENTION

The invention relates, in general, to the technical field of motor vehicle suspensions.

The invention relates more specifically to a filter sub-assembly for an upper-stop assembly of a motor vehicle suspension, to an associated assembly and to a suspension strut incorporating such a stop assembly, and to a method for assembling such a filter sub-assembly.

### STATE OF THE ART

Suspension struts of motor vehicles comprising a coil spring wound around a telescopic shock absorber are connected to the body of the vehicle at a multi-functional interface, referred to as the suspension upper stop, which in particular integrates functions of fastening to the body, rotationally guiding the upper end of the coil spring and/or of the suspension strut during rotation while the wheels are being steered, holding the rod of the telescopic shock absorber, where appropriate with vibratory filtration, and bearing a shock damper at the end of travel of the body of the telescopic shock absorber. Such a stop requires a large number of parts, some of which can be preassembled before mounting on the vehicle, and others must be assembled at the time of being fixed to the vehicle.

An example of an upper stop for a suspension strut of the preceding type is given by the document EP1591691A1. This stop comprises a rolling bearing comprising an upper washer, a lower washer and balls circulating on raceways formed on the upper and lower washers, as well as a rigid multifunctional part consisting of a stamped sheet and an elastomer filter block positioned between the upper washer and the multifunctional part. The multifunctional part comprises a plurality of fixing holes, each opening onto a bearing wall turned downward. Nuts are welded to the multifunctional part at the support walls, in the extension of the fixing holes. It is thus possible to secure the upper stop to the body of the vehicle using screws which pass through the fixing holes and are screwed into the nuts. Before it is mounted on the vehicle, the stop does not form a coherent whole. Precautions must also be taken to protect the metallic multifunctional part against corrosion.

The upper-stop assembly of the suspension strut shown in document DE 10 2009 059 168 A1 differs from the preceding one in particular by the fact that the multifunctional part is made of molded plastics material and has threaded metal inserts at the fixing holes. Such a part is potentially lighter than a sheet metal part, and is relatively insensitive to corrosion, except at the metal inserts. The manufacture of the multifunctional part in an injection mold with its overmolded metal inserts in practice leads to low plastics resistance with respect to impact damping forces.

Document FR 3 112 101 A1 describes an upper-stop assembly for a suspension strut that minimizes the final mounting steps on the vehicle, but remains compatible with high production rates. This configuration is offered by fixing interfaces on the multifunctional part each comprising an open fixing slit on a peripheral wall on the multifunctional part and each configured to receive at least a portion of a fixing element in a direction inclined relative to the axis of fixing of the rod, the arrangement of the slits guaranteeing that the fixing elements will not escape from the slits during assembly. The configuration described in this document makes it possible to avoid a step of permanently fixing the fixing elements to the multifunctional part, in particular by welding or overmolding, before mounting on the vehicle.

Despite these advantages, there is a constant drive to simplify assemblies, in particular by reducing the number of parts in the upper-stop assembly, which enables on the one hand to reduce assembly operations, and on the other hand to reduce the number of suppliers involved in this assembly.

### DISCLOSURE OF THE INVENTION

The invention aims to remedy some or all of the disadvantages of the current state of the art, in particular by proposing a simple solution that minimizes the final assembly steps on the vehicle, while remaining compatible with high production rates.

To this end, according to a first aspect of the invention, a filter sub-assembly for an upper-stop assembly of a suspension strut of a motor vehicle is proposed, the filter sub-assembly comprising:
a filter block made of elastomer material, the filter block extending along a reference axis and having an interface for securing one end of a rod of a shock absorber of the suspension strut;
a lower support of the filter block, having an annular central portion bearing against a lower face of the filter block and passed through axially by a passage for the end of the rod of the shock absorber, the lower support having an annular peripheral portion surrounding the annular central portion; and
a cover of the filter block, comprising a central portion bearing against an upper face of the filter block, and a peripheral portion surrounding the central portion and bearing against the annular peripheral portion of the lower support,
   characterized in that the filter sub-assembly further comprises a locking washer, a first element from among the lower support and the cover being located axially between the locking washer and a second element from among the lower support and the cover, flaps and notches being formed on the locking washer and the second element, each of the flaps formed on a part from among the locking washer and the second element being associated with one of the notches formed on another part from among the locking washer and the second element, the locking washer being movable relative to the second element between:
a relative approach position and a relative position of interpenetration by means of relative translational movement between the locking washer and the second element along the reference axis such that, in the relative interpenetration position, each of the fixing flaps penetrates into the associated notch,
the relative interpenetration position and a relative assembly position by means of relative rotational movement between the locking washer and the second element about the reference axis such that, in the relative assembly position, each of the fixing flaps is housed in a circumferential extension of the associated notch and is axially retained therein bearing axially against a rim of the associated notch.

According to one embodiment, the second element is a metal part, preferably a stamped sheet.

According to one embodiment, the locking washer is a metal part, preferably a stamped sheet.

According to one embodiment, at least some of the fixing flaps project from the annular peripheral portion of the second element.

According to one embodiment, at least some of the notches are formed on the locking washer.

According to one embodiment, the peripheral portion of the first element is provided with a fixing orifice associated with each of the fixing flaps of the second element and passed through by the associated fixing flap, the peripheral portion of the first element being located axially between the annular peripheral portion of the second element and the locking washer.

According to one embodiment, the filter block is preloaded between the lower support and the cover of the filter block.

According to one embodiment, the lower support of the filter block is made of a single piece and metal.

According to one embodiment, the cover of the filter block is made of plastics material(s), where appropriate having reinforcements or inserts.

According to one embodiment, the filter sub-assembly comprises means for rotationally locking the relative assembly position, the rotationally locking means preferably comprising at least one resilient blade which is configured to at least partly penetrate one of the notches to rotationally lock the locking washer relative to the second element in the relative assembly position.

Preferably, the rotationally locking means comprise a plurality of resilient blades, each configured to at least partly penetrate one of the associated notches to rotationally lock the locking washer relative to the second member in the relative assembly position.

According to another aspect of the invention, it relates to an upper-stop assembly of a suspension strut of a motor vehicle, the assembly comprising:
a sliding or rolling bearing defining an axis of rotation;
a filter sub-assembly as described above, bearing directly or indirectly against the bearing.

According to one embodiment, the cover of the filter block comprises a peripheral portion provided with fixing openings which are configured to fix the filter sub-assembly to a body element of the motor vehicle.

According to one embodiment, an annular portion of a motor vehicle body element is axially fitted tightly between the annular peripheral portion of the second element and the locking washer, preferably between the annular peripheral portion of the first element and the locking washer, and even more preferably between the cover and the locking washer.

The invention also relates to a suspension strut for a motor vehicle, comprising a coil spring, a telescopic shock absorber, and a shock damper, characterized in that it further comprises an upper-stop assembly as described above.

According to another aspect, the invention also relates to a method for assembling a filter sub-assembly as described above, comprising at least the following steps:
moving from a relative approach position to a relative interpenetration position by means of relative translational movement between the first and the second element along the assembly axis so as to make fixing flaps penetrate into associated notches, each of the notches being associated with one of the elements from among the first and the second element and with one of the fixing flaps which is rigidly connected to the other of the first and the second element,
moving from the relative interpenetration position and a relative assembly position by means of relative rotational movement between the first and the second element about the assembly axis so that, in the relative assembly position, each of the fixing flaps is housed in a circumferential extension of the notch associated with the relative interpenetration position and is retained axially therein to fix the cover to the lower support of the filter block.

According to one embodiment, the final assembly of the filter sub-assembly is carried out concomitantly with the fixing of said filter sub-assembly to a body element. To do this, a partial assembly of the filter sub-assembly is carried out beforehand, and it is held in place by radial interference between outer peripheral surfaces of the flaps and inner peripheral surfaces of the fixing orifices of the cover.

### BRIEF DESCRIPTION OF THE FIGURES

Other features and advantages of the invention will become apparent on reading the following description, with reference to the appended figures, which show:

FIG. 1: a sectional view of a top part of a motor vehicle suspension strut, and of a suspension upper-stop assembly of this suspension strut, according to a first embodiment;

FIG. 2: an isometric perspective view of the assembly of FIG. 1;

FIG. 3: an isometric perspective and exploded view of a suspension upper-stop assembly according to a second embodiment;

FIG. 4: a partially exploded perspective view of the suspension upper-stop assembly of FIG. 3, in which a filter sub-assembly is shown unexploded;

FIG. 5: a perspective and partially exploded view of the suspension upper-stop assembly of FIG. 3;

FIG. 6: a view of the suspension upper-stop assembly of FIG. 3 in a relative interpenetration position of fixing flaps in associated notches with the locking washer in the unlocked position;

FIG. 7: a view of the suspension upper-stop assembly of FIG. 3 in a relative assembly position of the fixing flaps in the associated notches with the locking washer in the locked position;

FIG. 8: an isometric perspective sectional view of the suspension upper-stop assembly of FIG. 3 in a relative approach position between a lower support and a cover;

FIG. 9: a sectional view of an isometric perspective of the suspension upper-stop assembly of FIG. 7;

FIG. 10: a sectional view of a top part of a motor vehicle suspension strut, and of a suspension upper-stop assembly of this suspension strut, according to the second embodiment in the relative assembly position of FIG. 7;

FIG. 11: a perspective and partially exploded view of a suspension upper-stop assembly according to a third embodiment;

FIG. 12: an isometric perspective sectional view of the suspension upper-stop assembly of FIG. 11 in a relative interpenetration position of the fixing flaps in the associated notches, with the locking washer in the unlocked position;

For greater clarity, identical or similar elements are identified by identical reference signs in all of the Figures.

### DETAILED DESCRIPTION OF ONE EMBODIMENT

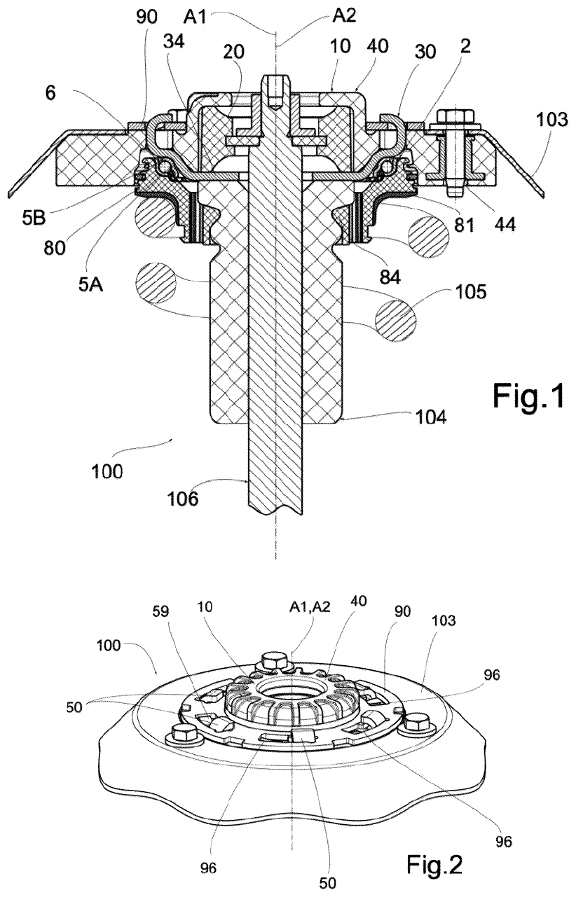

FIG. 1 shows the upper part of a suspension strut, bearing on a vehicle body element 103, in this case in the form of an inverted frustoconical bowl. The suspension strut comprises a coil spring 105, a telescopic shock absorber 106 located inside the coil spring 105, and a suspension upper-stop assembly 100, providing an interface between the body 103 on the one hand, and the coil spring 105 and the telescopic shock absorber 106 on the other hand.

The upper-stop assembly 100, also shown in FIG. 2, comprises a bearing 2 resting on an annular bearing support 80 based on a spring filtration element itself resting on the upper turn of the coil spring 105, and a shock damper 104. The assembly 100 comprises an attachment part, placed radially inside the bearing support 80, this attachment part comprising an inner skirt 84 furthermore positioned radially inside the bearing 2, the inner skirt 84 comprising a hooking shape for an upper end of a protective bellows (not shown) of the shock absorber 106.

The upper-stop assembly 100 further comprises a filter sub-assembly 10 also forming a cover of the bearing 2, the filter sub-assembly 10 forming a filter block 20 made of elastomer material located radially and axially within the filter sub-assembly 10, a rigid single-piece lower support 30 of the filter block 20, the lower support 30 being located between, here in particular interposed between, the filter block 20 and the bearing 2, and a cover 40 of the filter block 20.

The bearing 2 has the function of allowing the upper turn of the coil spring 105 to rotate when the coil spring 105 contracts and relaxes, or when the wheels are being steered, by rotationally guiding the bearing support 80 about a rotation axis A2. The bearing 2 is here a rolling bearing and comprises a lower washer 4 made of a stamped sheet, an upper washer 5 made of a stamped sheet defining the axis of rotation A2 and rolling bodies 6, in this case balls, rolling on raceways 7, 8 formed on the lower 4 and upper 5 washers to rotationally guide the lower washer 4 relative to the upper washer 5 about the axis of rotation A2. The rolling bearing 2 is oblique-contact, and the rolling bodies 6 are in contact with a radially outer region of the raceway 8 of the upper washer 5 and with a radially inner region of the raceway 7 of the lower washer 4, the inner region being radially inside the outer region relative to the axis of rotation A2. The balls are separated and kept approximately equidistant using a cage 6′.

The suspension strut is oriented in such a way that the assembly 100 is largely located “under” the body 103 and the coil spring 105 is at least partly located “under” the assembly 100.

The annular bearing support 80 can be made for example of plastics material, or of metal alloy, for example made of aluminum injected under pressure, with or without a reinforcing insert, and forms a planar annular mating face turned axially relative to the axis of rotation A2, opposite the bearing 2, as well as a cylindrical guide face turned radially outward.

The filter block support 30 and bearing support 80 together delimit a confined annular volume for the bearing 2. The filter block cover 40 itself forms an outer protective skirt 49 located radially outside and at least partly opposite an external peripheral face 82 of the bearing support 80.

The filter block 20 is formed of elastomer material and extends along a reference axis A1, the filter block 20 having an interface 21 for securing one end of a telescopic rod 102 of the shock absorber 106 of the suspension strut, which passes through a lumen formed in the shock damper 104 and a passage 33 of the support 30.

The filter block support 30 may be made of a metal alloy, for example made of steel or aluminum injected under pressure, and preferably a single piece, that is, one piece. Preferably, the support 30 is made of steel, from a stamped sheet. The filter block support 30 comprises a wall 34 having an upper face 35 facing the filter block and an opposite lower face 36 mating with a shock damper 104 of the suspension. More precisely, the filter block support 30 has an annular central portion 31 bearing against a lower face 22 of the filter block 20 and passed through axially by the passage 33 for the end of the rod 102 of the shock absorber 106, the lower support 30 having an annular peripheral portion 32 surrounding the annular central portion 31.

In this embodiment, the rigid one-piece support 30 of the filter block 20 is formed by a stamped sheet that forms a housing bowl of the filter block 20, disposed radially inside the bearing 2, in radial contact with said bearing 2, and a collar surrounding the bowl, placed on the bearing 2. More precisely, the filter block lower support 30 has a cylindrical skirt 39A configured to fit in an adjusted manner with a cylindrical portion 5A of the assembly 100 bearing 2 and an outer transverse shoulder 39B to abut an upper face 5B of said bearing 2 so that the filter sub-assembly 10 is directly bearing against the bearing 2.

The cylindrical skirt 39A and outer transverse shoulder 39B are carried by an intermediate annular portion 312 connecting the annular central portion 31 and the annular peripheral portion 32 between them, the cylindrical skirt 39A forming a cylindrical centering portion and transverse shoulder 39B forming a direct or indirect planar mating portion for the bearing 2.

The bowl housing the filter block 20, has a bottom 35 constituting an intermediate wall between the filter block 20 and the shock damper 104. A lower face of this intermediate wall is a support for the shock damper 104 of the suspension. The upper face of the intermediate wall is in contact with the filter block 20, the bottom 35 receiving the filter block 20 bearing axially against a lower face 22 of said filter block 20.

The support 30 of the filter block, in particular here the metal sheet constituting the rigid one-piece support 30, is annular and the bottom 35 of the bowl has a circular opening forming the passage 33 for the end of the rod 102 of the telescopic shock absorber 106. The filter block support 30 has a rotational symmetry about the reference axis A1 which also corresponds to a reference axis for the telescopic shock absorber 106 in its reference position, the shock damper 104 and the filter block 20. This axis of symmetry A1 is here parallel to, and coincident with, the axis of rotation A2 of the bearing 2, although other configurations are conceivable, in particular a configuration (not shown) in which the reference axis A1 intersects the axis of rotation A2 of the bearing 2.

The filter block cover 40 makes it possible to compress the filter block 20 no later than when mounting on the vehicle, so that the filter block 20 is preloaded between the lower support 30 and the filter block cover 40. The cover 40 can be made for example of rigid plastics material, if appropriate having reinforcements or inserts. The filter block cover 40 comprises a central portion 41 bearing against an upper face 23 of the filter block 20, and a peripheral portion 42 surrounding the central portion 41 and bearing against the annular peripheral portion 32 of the lower support 30. The filter block cover 40 further has an outer protective skirt 49 located radially outside and at least partly opposite an external peripheral face 82 of the bearing support 80 to delimit a sealing baffle 83 in order to protect the bearing 2.

A fixing between the cover 40 and support 30 is provided by fixing means for fixing the cover 40 to the filter block lower support 30. In this first embodiment, the fixing means for fixing the cover 40 to the filter block lower support 30 comprise flaps 50 for rigidly fixing the lower support 30 by projecting from the annular peripheral portion 32 of the lower support 30. These flaps 50 are distributed, and preferably regularly distributed, on the annular peripheral portion 32 of the support 30 and are six in number. These flaps 50 each have the shape of a hook and are configured to enter the fixing position in fixing orifices 60 of the cover 40. These fixing orifices 60 are located on the peripheral portion 42 of the cover 40 and are associated with the flap 50 for fixing the lower support 30. More precisely, in the fixing position, these fixing orifices 60 are passed through by a proximal portion 51 of the associated fixing flap 50 in an axial direction. Each flap 50 further has a distal portion 52 of the associated fixing flap 50 which extends at least along a component perpendicular to the axial direction and which overlaps with a mating surface on one side of the cover 40 opposite the peripheral portion 32 of the lower support 30 to fix, despite a preloaded force of the filter block 20, the cover 40 to the lower support 30 of the filter block.

The filter sub-assembly 10 further comprises a locking washer 90. This locking washer 90 is metal here, formed from a stamped sheet. In an assembly position, the cover 40 is located axially between the locking washer 90 and lower support 30, pairs of flaps 50 and notches 96 being formed on the locking washer 90 and lower support 30. It should be noted that according to a variant not shown here, a configuration could be obtained, in which the lower support 30 is located axially between the locking washer 90 and the cover 40.

The fixing of the cover 40 to the lower support 30 is achieved by the mating of the fixing flaps 50 with the notches 96, in the manner of a bayonet fixing. Indeed, the assembly of the filter sub-assembly 10 is provided according to a mechanical sequence of suitable movements.

In particular, the filter sub-assembly 10 comprises a plurality of fixing flaps 50 which are configured to cooperate with associated notches 96. Each of the flaps 50 of the locking washer is secured to one of the elements from among the locking washer 90 and the second element while the notches 96 are formed on the other of the locking washer 90 and the second element. In this way, cooperation of each of the fixing flaps 50 with an associated notch 96 allows the two elements to be assembled together, the first of those elements being either the lower support 30 or the cover 40 being interposed between the locking washer 90 and the second of those elements, either the lower support 30 or the cover 40.

The cooperation of the fixing flaps 50 with the associated notches 96 makes it possible to ensure at least axial locking of the filter sub-assembly 10, rotational locking being ensured by specially-adapted resilient locking means.

In this embodiment, each of the flaps 50 is formed on the lower support 30 and is associated with one of the notches 96 formed on the locking washer 90. The filter sub-assembly 10 thus comprises as many fixing flaps 50 as notches 96.

In a first step, during assembly, the cover 40 is positioned so as to be axially between the locking washer 90 and the lower support 30. The locking washer 90 and lower support 30 are movable relative to one another between a relative approach position and a relative interpenetration position. This movement is obtained by means of a relative translational movement between the locking washer 90 and lower support 30 along the reference axis A1 in such a way that, in the relative interpenetration position, each of the fixing flaps 50 penetrates the associated notch 96.

In a second step, to finalize the assembly and once the relative interpenetration position is attained, the locking washer 90 and lower support 30 are movable relative to one another between the relative interpenetration position and a relative assembly position. This movement is obtained by means of a relative rotational movement between the locking washer 90 and filter block lower support 30 about the reference axis A1 in such a way that, in the relative assembly position, each of the fixing flaps 50 is housed in a circumferential extension of the associated notch 96 and retained axially therein bearing axially against a rim of the associated notch.

The notches 96 can take various forms. However, they each have a first part 961 which extends parallel to the reference axis A1 and of which the opening is configured in its sizing to be crossed by an axial template of the flap 50, and a second part 962 of the notch 96 which extends circumferentially relative to the reference axis A1 of the filter sub-assembly 10 from the first part 961.

During the movement from the relative approach position to the relative interpenetration position, the distal portion 52 of each flap 50 forming a hook head is moved axially through a fixing orifice 60 associated with the fixing flap 50 of the lower support 30, then through the first part 961 associated with each of the notches 96. In the interpenetration position, the proximal part 51 of each fixing flap 50 forming a hook base is placed through the first part 961 associated with each of the notches 96.

Then, during the movement from the relative interpenetration position to the relative assembly position, the proximal portion 51 of each flap 50 is rotated and becomes housed in the circumferential extension 962 of the associated notch 96 with reduced cross-section relative to the template of each fixing flap 50 and in particular the template of each associated distal portion 52. The reduced cross-section of the circumferential extension forming the second part 962 of the notch 96 relative to the first part 961 provides axial engagement for the distal portion 52 of the associated fixing flap 50. In this way, in the relative assembly position, the distal portion 52 of each associated fixing flap 50 extends at least along a component perpendicular to the axial direction and overlaps with an associated mating surface on the cover side 40 opposite the peripheral portion 32 of the lower support 30.

The bearing surface is here carried by the locking washer 90 such that each fixing flap 50 is retained axially by the locking washer 90 in the relative assembly position, thus fixing the cover 40 to the filter block lower support 30.

Of course, the fixing orifices 60 of the cover 40 are sized to not constrain this rotational movement when the filter sub-assembly 10 moves from the relative interpenetration position to the relative assembly position, the peripheral portion 42 of the cover 40 carrying the fixing orifices 60 being located axially between the annular peripheral portion 32 of the lower support 30 and the locking washer 90.

The filter sub-assembly 10 further comprises rotationally locking means 59 of the relative assembly position so as to avoid reverse rotation. In this embodiment, the rotationally locking means 59 are integral with the part not bearing the fixing flaps 50, namely the cover 40.

These rotationally locking means 59 comprise at least one resilient blade, preferably a plurality of resilient blades, and preferably as many resilient blades as flaps 50.

Each of the resilient blades is positioned circumferentially adjacent to one of the fixing flaps 50, and extends from a base to a blade head extending circumferentially and along an axial component so as to be axially protruding, on the side of the associated flap 50. At the same time, the flap axially penetrates the fixing orifice 60 of the cover 40, then in the notches 96, each associated blade extending circumferentially from a circumferential edge of said corresponding fixing orifice 60 also penetrates the associated notch 96 so as to form an obstacle to the rotation of the locking washer 90 when it is in the relative assembly position. The blades are formed by stamping.

In the interpenetration position, each flap 50 penetrates the first part 961 of the associated notch 96, the resilient blade being constrained to bear against a lower surface of the locking washer 90. During the rotational movement about the reference axis A1 from the interpenetration position to the relative assembly position, the proximal portion 51 of each flap 50 is rotated and is housed in the second part 962 of the notch 96, releasing, in the first part 961 of the notch 96, a surface in which the resilient blade comes into view in the relative assembly position and the resilient release of which places the corresponding blade into the space defined by the first part 961 of the notch 96. In this position, the heads of each locking blade 59 form an obstacle in the associated notches 96 and are each placed in the thickness of the lock washer 90 to block any rotation that would tend to move it from the relative assembly position to the interpenetration position.

In the assembly method, during the step of moving from the relative approach position to the relative interpenetration position, the translation of the cover 40 and support 30 is such that the parts approach, the filter block 20 being located between these two parts. It is during this step that the filter block 20 is brought into compression by the cover 40 and the lower support 30, so that the filter block 20 is preloaded between the lower support 30 and the filter block cover 40. The relative rotation of the cover 40 and lower support 30 during the movement from the relative interpenetration position to the relative assembly position then makes it possible to axially lock the filter sub-assembly 10 and the compressed position of the filter block 20 to ensure preloading.

Thus, and generally, the filter sub-assembly includes a first element from among the lower support 30 or cover 40 located axially between the locking washer 90 and a second element from among the lower support 30 or the cover 40, flaps 50 and notches 96 being formed on the locking washer 90 and the second element, each of the fixing flaps 50 formed on a part from among the locking washer 90 and the second element being associated with one of the notches 96 formed on another part of the locking washer 90 and the second element, the method for assembling the filter sub-assembly 10 comprising at least the following steps:
moving from the relative approach position to the relative interpenetration position by means of relative translational movement between the first and the second element along the assembly axis A1 so as to make fixing flaps penetrate 50 into associated notches 96, each of the notches 96 being associated with one of the elements from among the first and the second element and with one of the fixing flaps 50 which is rigidly connected to the other of the first and the second element,
moving from the relative interpenetration position and the relative assembly position by means of relative rotational movement between the first and the second element about the assembly axis A1 so that, in the relative assembly position, each of the fixing flaps 50 is housed in a circumferential extension of the notch 96 associated with the relative interpenetration position and is retained axially therein to fix the cover 40 to the filter block lower support 30.

In the shown embodiment, the first element is the cover 40 and the second element is the lower support 30. However, in a variant not shown, the first element could be the support 30, and the second element would be the filter block cover 40. In this case, the annular portion 1031 of the body element 103 of the motor vehicle is clamped axially between the annular peripheral portion of the cover 40, and the lock washer 90.

In other variants also not shown, the fixing flaps 50 and the notches 96 can be distributed on both the first and second elements.

According to the embodiment, the final assembly of the filter sub-assembly 10 is carried out concomitantly with the fixing of said filter sub-assembly 10 to a body element 103. To do this, a partial assembly of the filter sub-assembly 10 is carried out beforehand, and held in place by radial interference between outer peripheral surfaces of the flaps 50 and inner peripheral surfaces of the fixing orifices 60 of the cover 40.

In this case, the cover 40 and support 30 are fixed independently of the filter sub-assembly 10 to the body element 103 of the motor vehicle by means of fixing openings 44.

The cover 40 is suitable for fixing the upper-stop assembly 100 to the body 103 of the vehicle. It comprises for this purpose a plurality of fixing interfaces distributed over a perimeter of the cover 40, three of them being in this embodiment, but potentially more or fewer. Each of these fixing interfaces includes an opening 44, which, in this embodiment, is a tapped hole playing the functional role of a nut configured to receive a fixing screw, but may where appropriate be a hole to receive another fixing means, such as a rivet for example, or a screw/nut assembly. To rigidly fix the fixing screws, the threaded interface serving as a nut is made of metal by an insert attached locally at each opening 44 in the plastics material of the cover 40.

The nuts forming the fixing elements are, in this embodiment, “T”-shaped as seen in cross-section, to maximize the structural strength of the nut embedded in the plastics material of the cover 40. Alternatively, fixing elements of different shapes can be envisaged, for example parallelepiped.

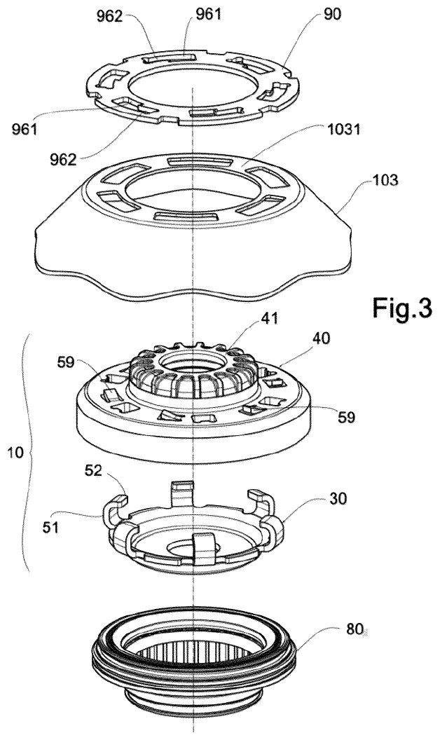

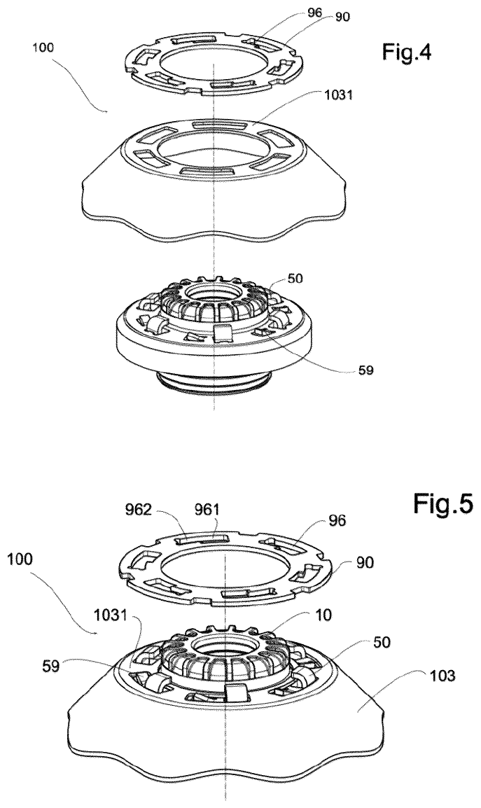

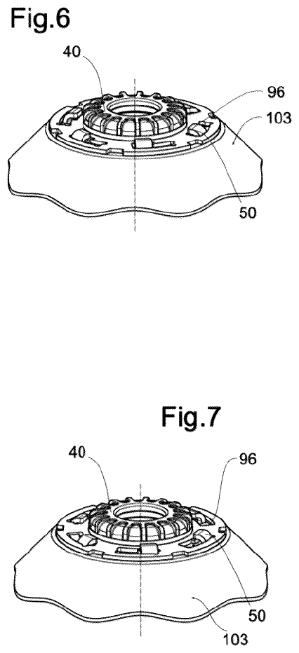

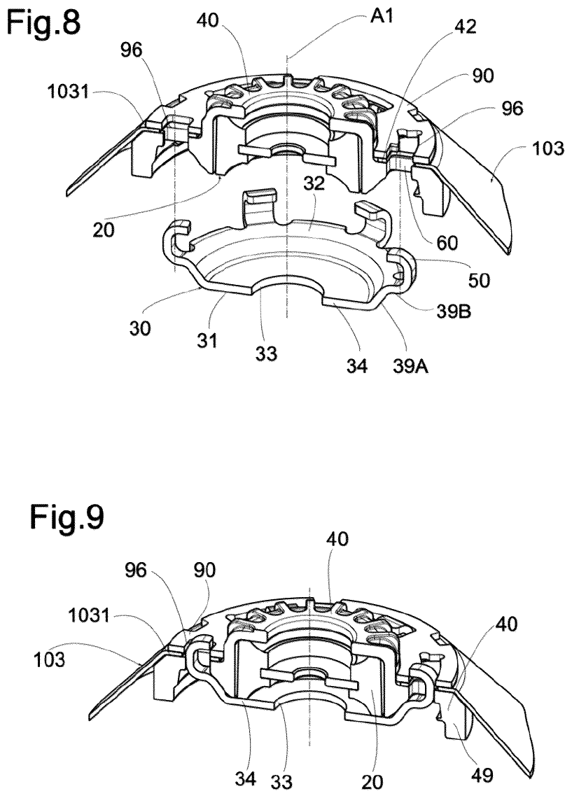

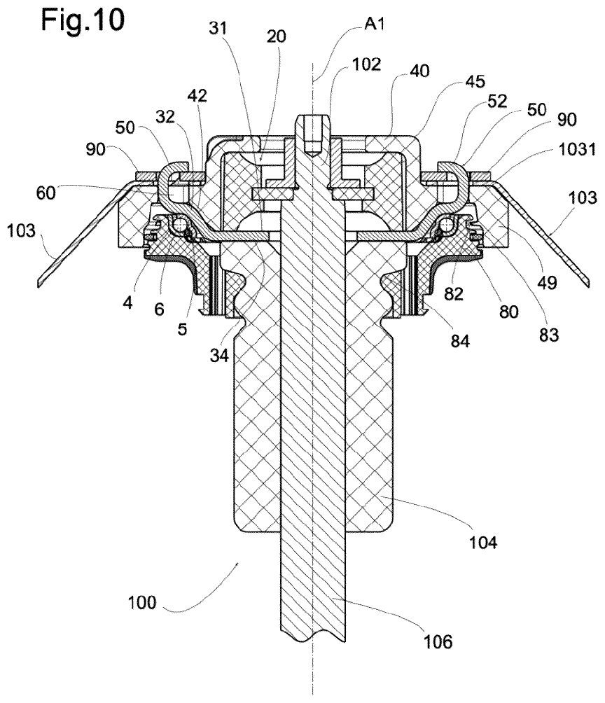

FIGS. 3 to 10 show a second embodiment. This second embodiment differs from the first essentially in that the filter sub-assembly 10 comprises fixing means for fixing the cover 40 to the lower filter block support 30, which are combined with the fixing of the filter sub-assembly 10 to a body element 103 of the motor vehicle. The filter block 20 is still preloaded here between the lower support 30 and the filter block cover 40.

On the contrary, in the first embodiment, the cover 40 is fixed to the lower filter block support 30 independently of the filter sub-assembly 10 to a body element 103 of the motor vehicle by means of the openings 44.

In this second embodiment, the fixing openings 44 for directly or indirectly fixing the filter sub-assembly 10 to a body element 103 of the motor vehicle are formed by the fixing orifices 60 associated with the fixing flaps 50 of the lower support 30. In this way, fixing functions are combined for a single opening, minimizing the number of holes and fixing interfaces on the cover 40.

In this embodiment, the motor vehicle body element 103 to which the filter sub-assembly 10 is fixed has an annular portion 1031 tightly fitted axially between the annular peripheral portion 42 of the cover 40 and the locking washer 90. In such a configuration, the locking washer 90 remains above the cover 40 to fix it in the same way as in the first embodiment, and has openings which are configured to face each of the holes 60 for fixing the cover 40 and to each be passed through by a resilient locking means to lock the assembled position.

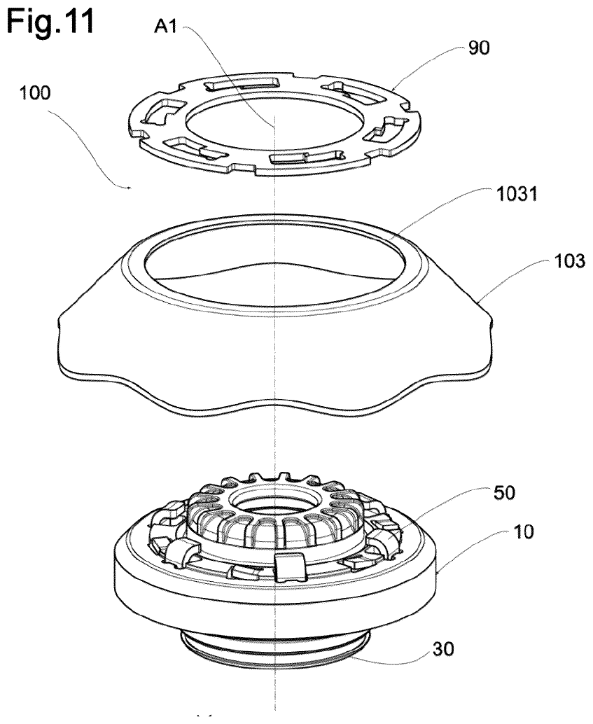

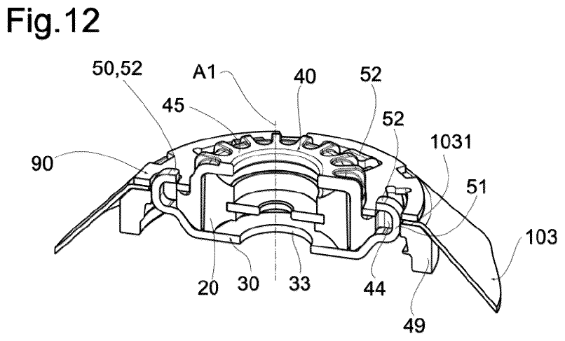

FIGS. 11 and 12 show a third embodiment. This third embodiment differs from the second embodiment essentially in that the annular portion 1031 of the motor vehicle body element 103 to which the filter sub-assembly 10 is fixed has no openings but is fixed by simply being clamped axially between the annular peripheral portion 42 of the cover 40 and the locking washer 90.

The annular portion 1031 of the body element 103 is arranged radially outward relative to the lower support 30. The centering of the annular portion 1031 with respect to the reference axis A1 is ensured by a radially inner edge of the annular portion 1031 and of circular shape configured to cooperate, or even be adjusted, around the radial outer edges of the set of fixing flaps 50, forming bearing zones circumscribed in a circle of complementary dimensions. The fixing flaps 50 are thus radially surrounded by the annular portion 1031 of the body element 103, which can come to bear against them in the event of radial displacement and thus remain coaxial with the reference axis A1. It should be noted that the tapered part of the cover 40 also provides a centering function in the body element 103.

Of course, the invention is described in the foregoing by way of example. It is understood that a person skilled in the art is able to produce different variant embodiments of the invention without departing from the scope of the invention.

The shape of the notches may for example vary without modifying its function.

It is emphasized that all of the features, as they are taught to a person skilled in the art from the present disclosure, drawings and attached claims, even though specifically they have been described in relation to other determined features, both individually and in any combinations, may be combined with other features or feature groups disclosed herein, provided that this has not been expressly excluded and that no technical circumstances make such combinations impossible or nonsensical.

1. A filter sub-assembly for an upper-stop assembly of a suspension strut of a motor vehicle, the filter sub-assembly comprising:
a filter block comprising an elastomer material, the filter block extending along a reference axis and having an interface for securing one end of a rod of a shock absorber of the suspension strut;
a lower support of the filter block, having an annular central portion bearing against a lower face of the filter block and passed through axially by a passage for the end of the rod of the shock absorber, the lower support having an annular peripheral portion surrounding the annular central portion; and
a cover of the filter block, comprising a central portion bearing against an upper face of the filter block, and a peripheral portion surrounding the central portion and bearing against the annular peripheral portion of the lower support,
wherein the filter sub-assembly further comprises a locking washer, a first element from among the lower support and the cover being located axially between the locking washer and a second element from among the lower support or the cover, flaps and notches being formed on the locking washer and the second element, each of the fixing-flaps formed on a part from among the locking washer and the second element being associated with one of the notches formed on another part from among the locking washer and the second element, the locking washer being movable relative to the second element between:
a relative approach position and a relative position of interpenetration by means of relative translational movement between the locking washer and the second element along the reference axis wherein, in the relative interpenetration position, each of the flaps penetrates into the associated notch,
the relative interpenetration position and a relative assembly position by means of relative rotational movement between the locking washer and the second element about the reference axis wherein, in the relative assembly position, each of the flaps is housed in a circumferential extension of the associated notch and is axially retained therein bearing axially against a rim of the associated notch.

2. The filter sub-assembly according to claim 1, wherein the second element is a metal part.

3. The filter sub-assembly according to claim 1, wherein the locking washer is a metal part.

4. The filter sub-assembly according to claim 1, wherein at least one of the flaps projects from the annular peripheral portion of the second element.

5. The filter sub-assembly according to claim 1, wherein at least one of the notches is formed on the locking washer.

6. The filter sub-assembly according to claim 1, wherein the peripheral portion of the first element comprises a fixing orifice associated with each of the flaps of the second element and passed through by the associated fixing flap, the peripheral portion of the first element being located axially between the annular peripheral portion of the second element and the locking washer.

7. The filter sub-assembly according to claim 1, wherein the filter block is preloaded between the lower support and the cover of the filter block.

8. The filter sub-assembly according to claim 1, characterized in wherein the lower support of the filter block comprises a single, metal piece.

9. The filter sub-assembly according to claim 1, wherein the cover of the filter block comprises a plastics material(s).

10. The filter sub-assembly according to claim 1, wherein the filter sub-assembly comprises rotationally locking means configured to rotationally lock the relative assembly position, the rotationally locking means comprising at least one resilient blade which is configured to at least partly penetrate one of the notches to rotationally lock the locking washer relative to the second element in the relative assembly position.

11. An upper-stop assembly for a suspension strut of a motor vehicle, the assembly comprising:
a plain or rolling bearing defining an axis of rotation;
a filter sub-assembly according to claim 1, bearing directly or indirectly against the bearing.

12. The upper-stop assembly according to claim 11, wherein the cover of the filter block comprises a peripheral portion provided with fixing openings which are configured to fix the filter sub-assembly to a body element of the motor vehicle.

13. The upper-stop assembly according to claim 11, wherein an annular portion of a body element of the motor vehicle is fitted tightly axially between the annular peripheral portion of the second element and the locking washer, preferably-between the annular peripheral portion of the first element and the locking washer, more preferably between the cover and the locking washer.

14. A suspension strut for a motor vehicle, comprising a coil spring, a telescopic shock absorber, and a shock damper, and an upper-stop assembly according to claim 11.

15. A method for assembling a filter sub-assembly according to claim 1, comprising at least the following steps:
moving from the relative approach position to the relative interpenetration position by means of relative translational movement between the first and the second element along an assembly axis so as to make fixing flaps penetrate into associated notches, each of the notches being associated with one of the elements from among the first and the second element and with one of the fixing flaps which is rigidly connected to the other of the first and the second element,
moving from the relative interpenetration position and the relative assembly position by means of relative rotational movement between the first and the second element about the assembly axis so that, in the relative assembly position, each of the fixing flaps is housed in a circumferential extension of the notch associated with the relative interpenetration position and is retained axially therein in order to fix the cover to the lower support of the filter block.

16. The method for assembling a filter sub-assembly according to claim 15, wherein a final assembly of the filter sub-assembly is carried out concomitantly with the fixing of said filter sub-assembly to a body element.
